(19) United States
(12) Patent Application Publication
(10) Pub. No.: US 2006/0074172 A1
(43) Pub. Date: Apr. 6, 2006

(54) Antiglare and antireflection coatings of surface active nanoparticles

(75) Inventors: Arthur J. Yang, Bethesda, MD (US); Ruiyun Zhang, York, PA (US)

Correspondence Address: MAYER, BROWN, ROWE & MAW LLP, 1909 K STREET, N.W., WASHINGTON, DC, 20006, US

(73) Assignee: Optimax Technology Corporation, Ping Chen (TW)

(21) Appl. No.: 10/514,018

(22) PCT Filed: Sep. 8, 2003
(86) PCT No.: PCT/US03/27780

§ 371 Date: Aug. 23, 2005

Related U.S. Application Data
(60) Provisional application No. 60/411,754, filed on Sep. 19, 2002.

(51) Int. Cl. B60C 1/00

(52) U.S. Cl. 524/492

(57) ABSTRACT

A process for preparing durable anti-reflection coatings includes forming a self assembling gradient layer between a first phase of a low refractive index and a second phase of a high refractive index, the gradient layer having a refractive index between that of the first and second phases at the interface of the first and second phases, as well as coatings and articles formed from this process.

### CROSS REFERENCE TO RELATED APPLICATION

This application claims priority from U.S. Provisional Ser. No. 60/411,754, filed Sep. 19, 2002, which is incorporated herein, in its entirety, by reference.

### SUMMARY OF THE INVENTION

The present invention, in one embodiment, relates to antiglare and/or antireflective coatings, coated substrates and methods for making same devices and products made therefrom.

### BRIEF DESCRIPTION OF THE DRAWINGS

FIG. 1 is a schematic representation in elevation of a cross-section of an embodiment of an anti-reflection coating of the present invention.

FIGS. 2A-2D are drawings which illustrate the relationship between liquid-solid contact angle (θ) and degree of particle emergence from a liquid-air interface.

FIG. 3 is a graph showing measured Gloss versus Haze for two coatings according to embodiments of the present invention

FIG. 4 is a diagram illustrating increased scattered light in the Lambertian portion for coatings according to embodiments of the present invention.

FIG. 5 is a schematic drawing illustrating a multi scattering process due to light reflection from interfaces of nanoparticles residing at the interfaces of a coating.

FIG. 6 shows a particle size distribution of a sample of nanoparticles prepared in accordance with one embodiment of the present invention.

FIG. 7 is a schematic diagram illustrating the arrangement used to measure the 5° surface reflectance over a wavelength range of visible light.

FIG. 8 is a plot of reflected light as a function of wavelength for antireflective coatings according to embodiments of the invention.

FIGS. 9A and 9B are Atomic Force Microscopy (AFM) images of the densely packed array of nanoparticles of an embodiment of the antireflective coating of the present invention showing a direct observation of the structure morphology (9A) and a 3D profile of the surface (9B) taken from the same spot of the sample.

FIGS. 10A-10C are schematic views of known antireflection coatings.

Among various optical applications, high-quality, functional coatings are often of importance. In order to achieve the high optical quality, the surface of an optical device, in addition to functioning as the protection layer against damages and contaminations, should also, by design, be an active part in the total light path which can significantly enhance the device's performances. Functions of the top layer, e.g., protection against scratch, stain, static charges accumulation, or reduction in viewing angle dependence, glare, reflection, and so forth, may be accomplished by the application of functional coating layer(s).

With a tremendous surge in the use of hand-held telecommunication or computerized apparatuses such as cellular phones, palm devices or portable on-line tools, their respective display devices are often required to pass much harsher quality and endurance tests commensurate to their use in an outdoor environment. Consequently, their top functional coating, whether for the purpose of improving the image quality or protecting the device surface, should be significantly upgraded to meet new challenges.

Compared with a desk-top unit, these smaller devices, including laptop computers, are more likely to be operated under a less controllable lighting environment. The reflection of the external lighting from the top surface of a display, even though representing only a minor percentage (4˜8% in normal incidence) of the total incident intensity, could still be too bright for achieving the desired display quality. The detrimental effects from a surface reflection, whether it is attributed to a reduced contrast ratio or an interfering image of an external object, are undesirable, and should be minimized. The lowering of specular reflection from a top surface may be achieved either by reducing its intensity (i.e. AR, antireflection, treatment) or by substantially diffusing the directions of the colligated reflection beam (i.e. AG, antiglare, treatment).

Because the largest change in refractive index occurs at the interface between air (n˜1) and the substrate (n˜1.5), an effective AR or AG coating of a display substrate should be present at the topmost layer, i.e., in direct contact with the air or ambient surroundings, and therefore, should be a sufficiently durable coating layer to protect the device against abrasions and scratches. Preferably, therefore, the AR or AG function are to be built into the hard coating at the topmost layer of a display device. The simplest approach so far is by adding either inorganic particles or polymer beads within a hard coating formulation so that its surface is roughened just enough to diffuse the specular reflection (an AG hard coating).

An AR coating is generally more sophisticated than an AG coating. An AR coating normally requires creation of a precisely controlled multilayer structure that could engage reflections from each interface to a destructive interference in the viewing direction. Such a multi-layered AR coating must have a prescribed combination of refractive index variations as well as layer thickness in order to achieve the desired destructive interference over an entire visible spectrum. Furthermore, for achieving such a destructive interference, each layer's thickness must be controlled within the precision of several to ten nanometers; making its production (normally by a vapor deposition process) much more difficult and more expansive than that achievable by an ordinary coating process.

While a multi-layered AR coating by vapor deposition is effective in reducing reflection intensity, it is not effective, due to the flatness of top surface, in diffusing the (reduced) specular reflection. When used under a bright outdoor lighting condition, an AR coating, unless able to achieve 100% reduction in reflection across the whole visible spectrum, may still show a weak, and sometimes even colored, image of a bright external object. Thus, for a display device to be used under various external lighting environments, a top coating with combined AR and AG functions would be more desirable and of a higher value.

To achieve dual AR and AG effects, a surface coating layer should accomplish both destructive interference of reflection as well as diffusion of the colligated reflection from the top surface. The traditional ¼ wavelength (¼λ) AR coating, and even the multiple layers interference coating, created by vapor deposition could not, due to surface flatness, diffuse the residual specular reflection. In order to have an antiglare effect, the surface should deviate from a plane geometry at a length scale not too small compared with the wavelength. (For example, a curvature at molecular scale would be too small to diffuse a reflective light in visible range).

The present invention in one embodiment thereof, utilizes nanoparticles with a precisely controlled size (in the range from several tenths to one or more λ) to form a top coating layer which may achieve AR and AG effects simultaneously.

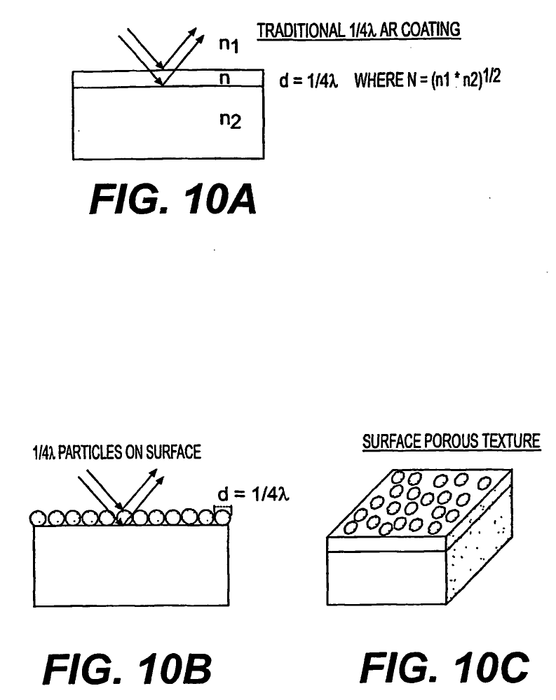

In order to achieve a pronounced AR effect, the surface coating layer should be formed with a prescribed variation in refractive index as well as an ordered arrangement in nanodomains (for example, ˜¼ wavelength) so that the reflected lights are out of phase with each other. The appended FIGS. 10A, 10B and 10C are illustrations of a few approaches already existing in the field.

FIG. 10A represents a traditional ¼ wavelength AR coating. In order to achieve a complete cancellation, the refractive index of the coating must equal (n₁·n₂)^{1/2}. For any coating layer interfaced with air, where n₁ is close to 1 and n₂ is normally ˜1.5, the refractive index of the coating must be lowered to about 1.22. The lowest refractive index of existing homogeneous materials is about 1.33. Further, even if n=1.22 were achievable, the effective range of one layer coating would be limited to near one wavelength; not sufficient for the complete visible spectrum. A multilayer coating with a prescribed combination of refractive indexes and thickness such that the destructive interferences occurs among the reflections from several different interfaces and over a frequency range was a solution to both problems. However, constructing such a sophisticated and precisely layered structure is challenging, especially with regards to the processing speed and cost.

Alternative one-layer approaches intending to lower the difficulties and the cost of making an AR coating (such as those represented by FIGS. 10B and 10C) require a porous structure in order to reduce the average refractive index of the top layer to near 1.22. FIG. 10B represents an example of a coating of which particles are deposited by electrostatic attraction (see H. Hattori, Adv. Mater., 13, No. 1, pp 51-53 Jan. 5, 2001). FIG. 10C represents an example of nanophase-separated polymer blend coating prepared by the evaporation of the monomer solvent in order to create a nanopore structure at the surface (see S. Walheirn, et al, Science, 1999, 283, 520).

Other ways of creating similar surface nanopore structure are cross-referenced in the article by H. Hattori mentioned above and include, for example, the etching or leaching of glass, sol-gel synthesis, sputtering, selective dissolution, dip coating, and gratings.

Most of these approaches accomplished a low refractive index layer on the top surface by mixing the bulk material with air on a subwavelength scale. The idea might be attributed to the “Moth-eye structure” discovered on the cornea of night-flying moths first by C. G. Bernhard, “Structure and functional adaptation in a visual system” Endeavor 26, 79-84 (1967). However, an AR structure intended for display application, unlike a moth eye, must also be able to sustain regular physical impacts without incurring any damages and this may not be achievable in these alternative approaches.

According to embodiments of the present invention high-performance AR coating based on use of nanoparticles, may be achieved by a processing method which produce these precise nanostructures reasonably fast and cost-effectively and provide an AR coating having adequate mechanical strength and robustness for the intended area of application. To achieve adequate mechanical strength and robustness embodiments of the present invention provide an AR layer which remains on top of any other functional layers and, can provide sufficient durability to withstand mechanical as well as chemical impacts which might otherwise cause permanent damages to the fine surface textures designed for the AR effect.

In one embodiment the present invention provides a process for preparing a durable anti-reflection coating effective for use in a low refractive index medium by forming a self-assembling gradient layer at the topmost surface of a second phase of a high refractive index wherein the gradient layer has a refractive index between that of the low refractive index medium and the second phase. In another embodiment, the present invention provides articles having an anti-reflection coating, which includes a self-assembling gradient layer at the topmost surface of a second phase of a high refractive index, said gradient layer having a refractive index between that of the low refractive index medium and the second phase. In this embodiment, the gradient layer has a refractive index between the refractive index of the ambient low refractive index medium and the refractive index of the second phase.

According to one embodiment of the invention, an antireflection coating is produced by depositing a coating composition comprised of supramolecules in a solvent solution of a curable resin under conditions whereby the molecular interacting forces between the supramolecules and the solvent solution is selected to cause the supramolecules to spontaneously rise to and partially extend from the topmost surface of the solvent solution. The concentration of supramolecules is sufficient to at least form a densely packed layer of the supramolecules partially embedded at the topmost surface of the curable resin when cured. In this embodiment, the refractive indexes of the supramolecules and the curable resin, after curing, are selected such that the resulting coating provides a gradient of refractive indices increasing from the exposed supramolecule particles at the topmost surface through the thickness of the cured resin. The method further includes driving off the solvent and curing the deposited curable resin. This process provides a densely packed array of supramolecules partially embedded at the topmost surface of the cured resin to provide an antireflection coating.

In one embodiment, the supramolecules are silica nanoparticles. In another embodiment, the supramolecules are polymeric nanoparticles. The density of the packing of the supramolecules need not be uniform over the entire surface. Similarly, the extent to which the supramolecules are embedded within the topmost surface of the cured resin can and will be expected to vary depending on the differences in surface free energy of the supramolecules and the liquid media as well as the kinetics involved in applying the coating composition and the curing speed and such other factors as the concentration of the supramolecules in the coating composition. Those skilled in the art will be able to tune the coating composition for any combination of supramolecules, e.g., silica nanoparticles, which may include functional groups to promote the self-assembling process, to achieve the surface density packing to provide the desired antireflection and/or antiglare properties.

In an embodiment of the present invention, a composite layer is assembled by a roll coating process with nanoparticles densely packed and partially emerged on the top surface of such a coating layer. This type of structure may achieve a reasonable mechanical strength due to the binding between particles and the supporting resin layer. The exposed part contains air pockets between the particle surfaces to provide for the low average refractive index at the top half. Furthermore, the particles may be made of low refractive index substrate so that even the part submerged into the resin may still have an average refractive index lower than the supporting coating resin. The gradual change from a mixture of air (n˜1) and particles (n˜1.33) to that of particles and resin (n˜1.5) constitutes a gradient of refractive indexes, smoothing out the otherwise sudden change of refractive index from 1 to 1.5. In one embodiment, the diameter of the particle is controlled to be at about ½ λ of visible light so that the interferences from the gradient layer would be highly destructive.

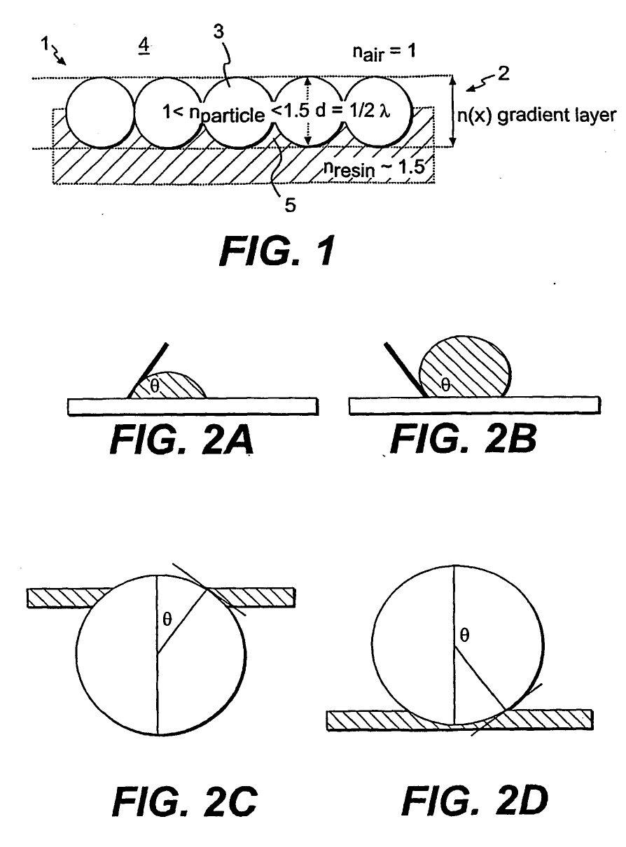

An embodiment of such antireflection coating composite layer according to this invention is schematically illustrated in FIG. 1. An antireflection coating (1) includes a self-assembled gradient layer (2) which includes a densely-packed array of nanoparticles (3), a first phase, usually air, of low refractive index (4), and a second phase of high refractive index (5). In practice, additional nanoparticles (not shown) may be present in the bulk of the second phase, usually resulting from the kinetics of the self-assembling process by which the dense array of nanoparticles are formed at the top most surface of the coating.

Using a refractive index gradient instead of a finite number of layers achieves a destructive interference from the integration of infinitely many sublayers with a much smaller difference in refractive index. If the composite refractive index is represented as a function of the penetration thickness, n(x), the collective interference effect may be approximated by the following equation:

$$I = {\sum }_{j} \frac{Δ n ( {x}_{j} )}{2 n ( {x}_{j} )} \cdot {ⅇ}^{\frac{2 π ⅈ \cdot 2 {x}_{j}}{λ}}$$

In a more accurate calculation, λ should also be a function of x. The effectiveness of the gradient approach, similar to other anti-reflection practices, depends on how precise one can control the variations in gradient as well as in thickness at the sub wavelength scale. However, the gradient approach, because of the averaging effect from integration, should be less restrictive than the other approaches cited above. For example, the thickness can be from ½ wavelength to several multiples of the ½ wavelength. Or, should such a slower gradient over a region of several wavelength be achievable, the exactness of the thickness can be proportionally relaxed. The comparison of the gradient approach to a one ¼ λ layer method can be illustrated by the following two diagrams representing cancellations of vectors with opposing phase angles:

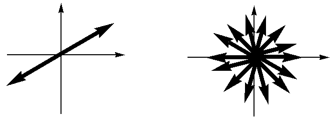

The left diagram, by a vector summation of two phases 180° apart, illustrates the destructive interferences of the reflections from the two interfaces separated by an exact distance of ¼λ. The magnitude of the vectors is proportional to the discontinuous change of refractive index at the two interfaces. In order to achieve a complete cancellation of the two vectors, the refractive index of the ¼λ coating layer must be exactly equal to (n₁·n₂)^{1/2}. While, in the right diagram, the interferences come from an integrated result of numerous reflection components from various layers in a gradient zone. The magnitude of each vector is much smaller because it is proportional to the difference in refractive index, Δn(x)/2n(x). The longer the gradient zone, the smaller the magnitude of the phase vectors and the smaller the magnitude of each reflection component. The continuous change of refractive index in a gradient zone leads to a continuous variation in phases angles of respective reflections. Consequently, the gradient zone according to an embodiment of the invention is at least ½λ or a multiple of it in order to cover a complete cycle of phase cancellation in reflection.

In order to maintain mechanical integrity, the refractive index gradient may be formed naturally by emerging particles which themselves are further supported by a strong binding to an underlying hard-coating resin layer. The thickness of the particle layer (i.e. the particle diameter) may be of about ½ λ at a minimum. Additionally, the formation of a gradient covering a thickness of the whole ½ λ requires the refractive index of emerging particles be lower than that of the resin layer. In an embodiment of the invention, the particles are densely populated in the top (emerging) layer while with least population in the bulk so that there would be negligible internal scattering due to its difference in refractive index from the resin.

The present invention provides an embodiment which creates particles with an optimized diameter, a low refractive index, and, a low surface free energy (compared with the resin system) so that the formation of a gradient layer is by a self-assembling process of these particles at the top surface layer during the application of the coating, for example, by a roll coating process.

For a particle of a micron, or smaller, size, the dominant interacting force is its interfacial tension (capillary phenomena). Therefore, the assembling of particles with a diameter of approximately ½ λ may be achieved by only lowering the particle surface free energy below that of the resin mixture. This goal may be accomplished in embodiments of this invention, by for example, providing a surface free energy lowering amount of fluorocarbon in a particle synthesized by a sol-gel process. At a sufficient content, the fluorine atom, having the lowest polarizability among all elements, can lower the surface free energy as well as the refractive index of a composite particle.

In one embodiment of this invention, the self-assembling gradient layer has a refractive index which gradually increases in magnitude between the interface of the ambient low refractive index medium with the gradient layer, and the interface of the second phase with the gradient layer.

In one embodiment of the present invention, the second phase of high refractive index has a refractive index greater than 1.4, for example, greater than 1.45, 1.5, 1.55 or 1.6.

The ambient low refractive index medium is the ambient surroundings of the coating, such as air or other gaseous atmosphere, or aqueous surroundings.

In one embodiment, the self-assembling gradient layer may be formed from a curable composition of monomers or oligomers, which polymerize to form a durable polymer or polymers upon a curing treatment. Such curable compositions, suitable additives for such compositions, and curing treatments are well known in the art. For example, those compositions described in U.S. Published Patent Application 2001/0035929, the disclosure of which is incorporated herein by reference, are suitable for use in the present invention. In one embodiment, the curable composition is a polyacrylate. In an embodiment of the invention, the curing treatment is a heat treatment. In another embodiment, the curing treatment is by actinic radiation, such as ultraviolet radiation or electron beam radiation.

In one embodiment, the self-assembling gradient layer may be formed by creating a difference between the surface energies of a solid and a liquid. The difference between the surface energies of a solid and a liquid determines the contact angle in a wetting experiment. The same contact angle also directly dictates the level of emergence when a particle made of that solid is floating at the liquid-air interface. The relationship of a contact angle and the amount of emergence is illustrated by FIGS. 2A-2D. (Gravitational force is negligibly small at this length scale.)

Lowering the surface energy of a particle could help its flotation to the top surface of a hard coating. However, the increased population of particles at an interface could also promote aggregation of the particles. In practicing this concept, adequate amount of surfactants may be used for the fine-tuning of the self-assembling process at a liquid-air interface.

Self-assembling nanoparticles are nanoparticles that are capable of forming a densely packed array at the top most layer of a supporting matrix from a curable composition within a desirable period of time upon mixing with a curable composition. In one embodiment, such mechanism by which nanoparticles may self-assemble occurs by flotation of the nanoparticles in the curable composition.

When these nanoparticles are partly submerged into a curable composition, the resulting partially submerged array of nanoparticles will have an average refractive index lower than the resulting supporting cured composition. In one embodiment of the invention, the nanoparticles are densely populated at the topmost surface of the coating (i.e., at the interface with the ambient low refractive index medium) and sparsely populate the second phase so that there would be negligible internal scattering due to the difference in refractive index between the nanoparticles and curable composition.

Without wishing to be bound by any particular theory or explanation, it is believed that the gradual change in refractive index between the ambient low refractive index medium and the second phase that is produced by the gradient layer of the antireflection coatings constitutes a gradient of refractive indexes. It is further believed that this gradient of refractive indexes is responsible for smoothing out the otherwise sudden change of refractive index that is often experienced from the first phase (typically air with an refractive index near 1) to the second phase (that has a higher refractive index, for example, 1.5).

The surface curvature or roughness of a surface is thought to be responsible for an antiglare effect, by diffusing the directions of the surface reflection. The same effect could cause high haze. The anti-reflection function, on the other hand, reduces the surface gloss and weakens the glare by creating destructive interferences. Such a gloss reduction mechanism, by itself, does not increase the haze, or compromise the clarity. Therefore, blending anti-reflection and anti-glare compositions together, by using the gradient layer of the various embodiments of the present invention, provide high resolution when applied to a display device.

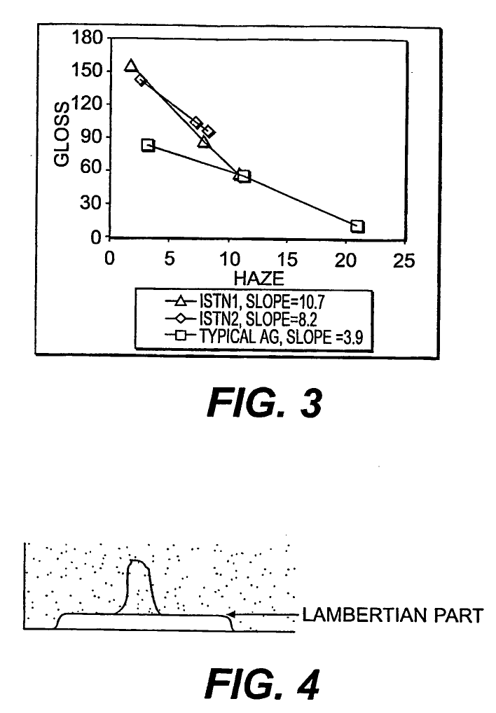

Dual anti-reflection and anti-glare properties of the coatings of the present invention may be determined by plotting the gloss values versus the haze values of a series of samples. If a coating formulation reduces the gloss by anti-glare effect alone, the slope of the plot (i.e., unit of gloss reduction per unit of haze increase) is flatter than that of a coating with combined anti-glare and anti-reflective effects. This effect is illustrated in FIG. 3 which shows a plot of gloss v. haze for several coatings reported in the Examples below.

Self-assembly of nanoparticles may be achieved by lowering the surface free energy of the nanoparticles to below that of the curable composition, thus facilitating nanoparticle flotation to the topmost surface of the curable composition. The level of emergence, when a nanoparticle made of that solid is floating at the liquid-air interface, is proportional to the contact angle between the liquid and solid in a wetting experiment, as illustrated by FIGS. 2A-2D.

In one embodiment, the nanoparticle incorporates a surface free energy-lowering amount of fluorine in the form of a fluorocarbon group. Examples of fluorocarbon groups that may be incorporated into the nanoparticles include perfluorocarbon groups, such as perfluoroalkyl, perfluoroalkene, perfluoroaryl groups, for example perfluorooctyl, perfluoroheptyl, perfluorohexyl, and perfluorobenzyl. In another embodiment, the fluorocarbon group my be a partially fluorinated group, such as a hydrofluorocarbon, for example, a tridecafluoro-1,1,2,2,-tetrahydrooctyl radical.

An anti-reflection coating layer including fluorine containing nanoparticles is characterized by being scratch resistant and having a low friction coefficient.

In one embodiment, the surface energy of the nanoparticle is lowered by treatment with a surface active compound. Surface active compounds may be used to adjust the surface energy difference between the curable composition and the nanoparticle, to thereby promote the self-assembly of nanoparticle arrays. In one embodiment the surface active compound is a surfactant. Suitable surfactants include those described in JP-A-8-142280 or U.S. Pat. No. 6,602,652, the disclosures of which are incorporated by reference. In one embodiment, mixtures of one or more surfactants may also be used. In one embodiment, the surfactant comprises dimethyldioctadecylammonium bromide (“DDAB”).

In one embodiment of the invention, the nanoparticles are between several tenths of a visible light wavelength to one or several wavelengths of visible light in diameter. In one embodiment of the invention, the nanoparticles are between about one eighth and about one wavelength of light in diameter. In another embodiment, the nanoparticles are between one quarter and one-half wavelength of light in diameter. In another embodiment of the invention, the nanoparticles are about one-half wavelength or multiple thereof, in diameter. In another embodiment, the nanoparticles are between about 100 and about 600 nanometers in diameter. In another embodiment, the nanoparticles are at least substantially uniform in size and shape. In another embodiment the particles are spherical or at least substantially spherical.

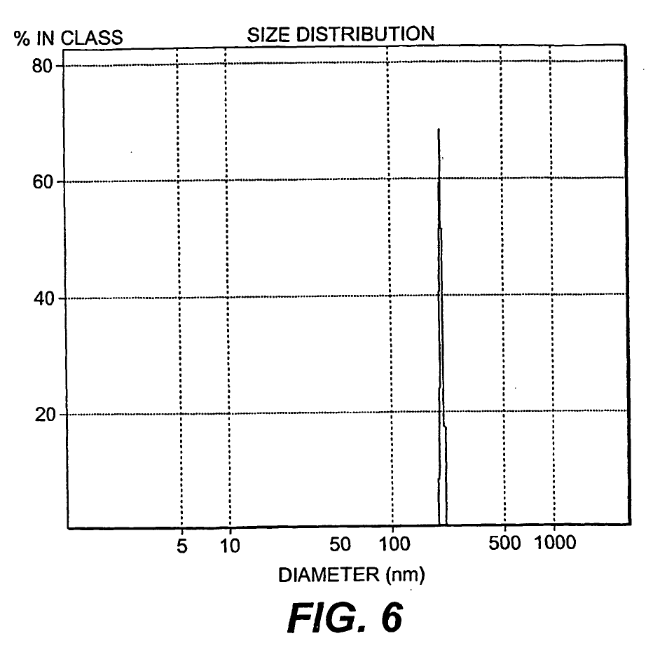

In one embodiment of the present invention, the nanoparticles are uniform in diameter, for example, within a five percent variance in diameter among particles. A particle size distribution of nanoparticles according to an embodiment of the invention is illustrated in FIG. 6.

In an embodiment of the invention the nanoparticles comprise silica nanoparticles. In another embodiment of the present invention, the nanoparticles comprise silica nanoparticles that further comprise fluorocarbon groups.

Silica nanoparticles of substantially uniform cross-section may be prepared by a sol-gel type synthesis, such as described by Stöber et al., J. Colloid Interface Sci. 26, 62 (1968). The process may proceed by hydrolysis of tetraethyl orthosilicate (TEOS) in a solution of ethanol, water, and ammonia, such as described by Brinker et al., J. Non-Cryst. Solids 48, 47-64 (1982), to form reactive silanol groups and hydroxyl groups. Subsequently, the silanol groups condense to form a polymer chain. As the polymer chain increases in length from the two reaction steps, the polymer solubility decreases until the chain no longer dissolves in the solution, such as described by Bogush et al., J. Colloid Interface Sci. 142, 1-18 (1991), resulting in nano-sized silica particles of uniform size and shape. The disclosures of these references are incorporated herein by reference.

The Stöber process may be modified to allow incorporation of a desired group, for example, a fluoroalkyl group. Such incorporations may occur via use of silane coupling agents, for example, 3-aminopropyl trimethoxysilane (APS), or by the appropriate choice of starting materials such as (tridecafluoro-1,1,2,2-tetrahydrooctyl)triethoxysilane (“F-TEOS”) for fluorinated nanoparticles.

In another embodiment of the present invention, silica nanoparticles are formed by catalyzed hydrolysis of TEOS. For example, the following references describe such synthetic techniques and are incorporated herein by reference: Kawaguchi and Ono J. Non-Cryst. Solids 121, 383-388 (1990); Karmakar et al. J. Non-Cryst. Solids 135, 29-36 (1991); Ding and Day J. Mater. Res. 6, 168-174 (1991); Mon et al. J. Cer. Soc. Jap. 101,1149-1151(1993); Ono and Takahashi World Congress on Particle Technology 3, 20 1-11; Pope Mater. Res. Soc. Symp. Proc. 372, 253-262 (1995) and Pope, SPIE, 1758, 360-371 (1992). See Yang et al., Journal of Materials Chemistry 8, 743-750 (1998); Qi et al., Chem. Mater. 10, 1623-1626 (1998); and Boissiere and Lee Chemical Communications 2047-2048 (1999).

In one embodiment, the nanoparticles are composed of organic polymers, or organic-inorganic polymers containing silica or a silicon containing component, such as those described in U.S. Pat. No. 6,091,476, the disclosure of which is incorporated herein by reference. In embodiments of the present invention, low refractive index materials are used to form the nanoparticles.

One embodiment of the present invention provides a high-resolution, multi-functional, anti-reflection coating for an optical device, such as eyeglass lenses, telescope lenses, microscope lenses or other optical devices. An embodiment of the invention is a high-resolution, multi-functional, anti-reflection coating for a telecommunication device, for example, the display screen of a wireless or cellular telephone or PDA device.

In another embodiment of the present invention, the anti-reflective coating is applied to a substrate. In one embodiment the substrate is a glass, such as a flexible glass or a traditional glass. In another embodiment, the substrate is a polymeric material, such as polycarbonate, triacetyl cellulose (“TAC”), or any other substrate which may be appropriate for optical or display devices or such other devices for which wave propagation is at issue, for example, those disclosed in U.S. Published Application 2001/0035929 A1, the disclosure of which is incorporated herein by reference. In one embodiment, the substrate is flexible (e.g., it may be wound on a roll). In another embodiment, the substrate is transparent.

The present invention provides an embodiment which creates nanoparticles with a uniform diameter, a low refractive index, and a low surface free energy (compared with the resin system) so that the formation of a gradient layer is by a self-assembling process of these nanoparticles at the topmost surface of the coating.

The present invention provides an anti-reflection or anti-glare coating, or an anti-reflection and antiglare dual function coating, and also provides articles coated with any of these coatings.

In one embodiment, the coatings of the present invention can achieve dual AR and AG functions by formulation controls, for example by varying nanoparticle size and amount, viscosity or coater type, or by varying one of these formulation controls in combination with one or more processing controls.

In one embodiment of the present invention, the nanoparticles of the self-assembling gradient layer are used to increase the brightness level of a display in addition to achieving an AR and/or AG function. In one embodiment, the coatings of the present invention may increase the luminance of both the bright and the dark states as shown by a higher level of white muddiness. Embodiments of the present invention provide processes, coatings and articles that may produce coatings with high clarities as measured by the distinctness of image (“DOI”) test described herein.

One embodiment of the present invention provides a high-resolution AR and AG coating for liquid crystal displays.

In one embodiment, the formulation of the anti-reflection coating is applied to a flexible substrate, such as a flexible film or sheet, which may be transparent, by a roll coating process, at a speed of from, for example, 20 to 50 feet per minute, for example 30 feet per minute. Often, the qualities of the AR and/or AG coating obtainable from a roll-to-roll coating process varied substantially according to recipes as well as processing parameters such as resin viscosity, surfactants, solid contents, line speed, and coater types. In one embodiment of the present invention, the haze, gloss, and reflectance of a coating may be fine tuned by adjusting the recipe and processing conditions. The recipe and processing optimizations of this invention may be selected by those skilled in the coating arts.

In one embodiment, the anti-reflection coating is applied by dip coating, spin coating or spray coating.

Depending upon the speed of a coating process, including, for example, the rate of curing of the curable resin, some nanoparticles may rest below the dense, topmost surface array of nanoparticles, as a result of kinetic forces exceeding thermodynamic forces. This invention contemplates and includes embodiments wherein the nanoparticles may be present in the bulk of the cured resin second phase layer in such amounts which do not substantially or at all interfere with AR properties.

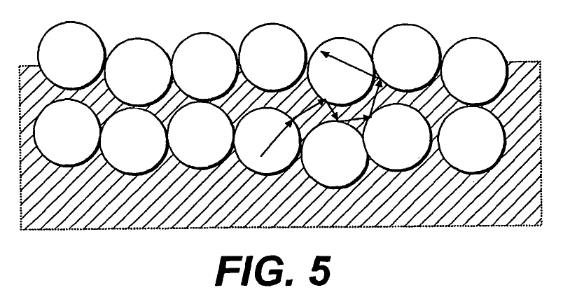

In one embodiment, the coatings of the present invention increase the Lambertian portion of the scattered light contributing to the antiglare effect (diffusive reflection) as well as the white muddiness. This effect is shown in FIG. 4. Without wishing to be bound to any particular theory, this phenomenon is believed to be a result of light scattering from multi layers of particles with a refractive index lower than that of the second phase of high refractive index. This situation is depicted in FIG. 5, which illustrates light reflection from interfaces of the particles residing at the interface of a coating. The total reflection at the interface of a light traveling from a high refractive index medium to a lower refractive index spheres led consecutive scatterings that diffused the directions of a propagating light. This surface scattering process may result in a loss of contrast level if the increase of luminance for a bright state is lower than for a dark state by proportion. In addition, however, it may also improve the viewing angle of a display device, depending on how the refractive indexes of this layer and the rest of the displaying device match each other. Therefore a self-assembled top layer with an adjustable difference in refractive index and geometrical features determined by particles sizes and aggregation may therefore adjust other crucial optical scattering properties of a display device such as the contrast ratio, viewing angles, and light distributions in addition to reducing reflection from outside lighting sources originally intended by this invention.

### EXAMPLES

In the following examples, the nanoparticles are made by a modified Stöber process of which the starting sol is a mixture of tetraethoxysilane (“TEOS”) and (tridecafluoro-1,1,2,2-tetrahydrooctyl)triethoxysilane (“F-TEOS”). Nanoparticles were formed in a medium of isopropanol (“IPA) with an ammonia catalyst. The nanoparticle size from this process was measured by light scattering (90 Plus Particle Size Analyzer, Brookhaven Instruments Corporation). The medium for nanoparticle sizing was ethanol. The nanoparticle suspensions were treated by ultrasound for 5 to 10 minutes before nanoparticle sizing. The fluoro-content in the nanoparticles was calculated based on the molar ratios of the reactants.

After mixing with an appropriate resin and photoinitiator, a UV curable coating can be made by a roll coating process.

### Example 1

In a reaction vial, 20 ml IPA, 1.6 ml TEOS and 0.4 ml F-TEOS were added and mixed with a magnetic stirrer at a high speed for two minutes. During the stirring, 2.21 ml deionized water and 1 ml concentrated NH₃/H₂O solution (NH₃ 28-30 wt %) were added to the mixture. The mixture was stirred for another 30 minutes. The clear mixture developed into an opaque white suspension. The suspension was aged for two days and then nanoparticle size was measured by light scattering. The nanoparticle size was around 300 nm. The molar ratio of F-containing silica to pure silica in the nanoparticles is 13:87.

### Example 2

In a reaction vial, 20 ml IPA, 1.4 ml TEOS and 0.6 ml F-TEOS were added and mixed with a magnetic stirrer at a high speed for two minutes. During the stirring, 2.21 ml deionized water and 1 ml concentrated NH₃/H₂O solution (NH₃ 28-30 wt %) were added to the mixture. The mixture was stirred for another 30 minutes. The clear mixture developed into an opaque white suspension. The suspension was aged for two days and then nanoparticle size was measured by light scattering. The particle size was around 210 nm. The molar ratio of F-containing silica to pure silica in the nanoparticles was 20:80.

### Example 3

In a reaction vial, 20 ml IPA, 1.2 ml TEOS and 0.8 ml F-TEOS were added and mixed with a magnetic stirrer at a high speed for two minutes. During the stirring, 2.5 ml deionized water and 1 ml concentrated NH₃/H₂O solution (NH₃ 28-30 wt %) were added to the mixture. The mixture was stirred for another 30 minutes. The clear mixture developed into a translucent suspension. The suspension was aged for two days and then the nanoparticle size was measured by light scattering. The nanoparticle size was around 160 nm. The molar ratio of F-containing silica to pure silica in the nanoparticles was 28:72.

### Example 4

In a reaction vial, 20 ml IPA, 1 ml TEOS and 1 ml F-TEOS were added and mixed with a magnetic stirrer at a high speed for two minutes. During the stirring, 2.5 ml deionized water and 1 ml concentrated NH₃/H₂O solution (NH₃ 28-30 wt %) were added to the mixture. The mixture was stirred for another 30 minutes. The mixture remained clear during stirring and aging. The light scattering was not able to obtain accurate nanoparticle size for this sample. The molar ratio of F-containing silica to pure silica in the nanoparticle was 37:63.

### Example 5

In a reaction vial, 20 ml IPA, 1.4 ml TEOS and 0.6 ml F-TEOS were added and mixed with a magnetic stirrer at a high speed for two minutes. During the stirring, 1.5 ml deionized water and 1 ml concentrated NH₃/H₂O solution (NH₃ 28-30 wt %) were added to the mixture. The mixture was stirred for another 30 minutes. The clear mixture developed into a translucent suspension. The suspension was allowed to age for two days and then the nanoparticle size was measured by light scattering. The nanoparticle size was 120 nm. The molar ratio of F-containing silica to pure silica in the nanoparticles was 20:80.

### Example 6

In a reaction vial, 20 ml IPA, 1.4 ml TEOS and 0.6 ml F-TEOS were added and mixed with a magnetic stirrer at a high speed for two minutes. During the stirring, 2.92 ml deionized water and 1 ml concentrated NH₃/H₂O solution (NH₃ 28-30 wt %) were added to the mixture. The mixture was stirred for another 30 minutes. The clear mixture developed into an opaque white suspension. The suspension was aged for two days and then the nanoparticle size was measured by light scattering. The nanoparticle size was 300 nm. The molar ratio of F-containing silica to pure silica in the nanoparticles was 20:80.

### Example 7

In a reaction vial, 20 ml IPA, 2.8 ml TEOS and 1.2 ml F-TEOS were added and mixed with a magnetic stirrer at a high speed for two minutes. During the stirring, 2.92 ml deionized water and 1 ml concentrated NH₃/H₂O solution (NH₃ 28-30 wt %) were added to the mixture. The mixture was stirred for another 30 minutes. The clear mixture developed into an opaque white suspension. The suspension was aged for two days and then nanoparticle size was determined by light scattering. The nanoparticle size was 250 nm. The molar ratio of F-containing silica to pure silica in the nanoparticles was 20:80.

### Example 8

In a reaction vial, 20 ml IPA, 1.6 ml TEOS and 0.4 ml F-TEOS were added and mixed with a magnetic stirrer at a high speed for two minutes. During the stirring, 2.29 ml deionized water and 2 ml concentrated NH₃/H₂O solution (NH₃ 28-30 wt %) were added to the mixture. The mixture was stirred for another 30 minutes. The clear mixture then developed into an opaque white suspension. The suspension aged for two days and then the nanoparticle size was determined by light scattering. The nanoparticle size was 400 nm. The molar ratio of F-containing silica to pure silica in the nanoparticle was 20:80.

### Example 9

As described above, the surface curvature or roughness, by diffusing the directions of the surface reflection, is responsible for the antiglare effect. The same effect may also cause high (reflection and transmission) haze and other undesirable effects mentioned above. The AR function, on the other hand, reduces the surface gloss and weakens the glare by creating destructive interferences. Such a gloss reduction mechanism, by itself, does not increase the haze, or compromise the clarity. Therefore, blending AR and AG together by using the gradient method disclosed here may improve the resolution of a display device.

One quick way to demonstrate this feature of a dual function (AR and AG) coating is by plotting the gloss values versus the haze values of a series of samples. If a coating formulation reduces the gloss by AG effect alone, the slope of the plot (i.e. unit of gloss reduction per unit of haze increase) is flatter than that of a coating with the combined AG and AR effects. This is demonstrated by the following series of experiments.

Haze and gloss measurements were measured for several compositions. The results are shown in FIG. 3. The curve of ISTN1, according to an embodiment of the invention, illustrates coatings containing F-silica with different fluorine content (from 5% to 27%), illustrating gloss decreases with increasing fluorine content. The curve of ISTN2, according to another embodiment of the invention, illustrates coatings containing a fixed amount of F-silica but a different amount of surfactant (Dimethyldioctadecylammonium bromide (DDAB)). The surfactant assists in reducing coagulation of the F-silica particles at the surface. For comparison, haze and gloss measurements were also made for a commercially available antiglare coated display device. Haze measurements were made by a Nippon Denshoku NDH-2000 instrument. Gloss measurements were made by a Nippon Denshoku VG-2000 instrument. As may be seen, the slope of gloss versus haze is substantially higher for the coatings according to the embodiments of the present invention.

### Example 10

The particle synthesis procedures described above were scaled up first to a batch size of 3 kg and then a batch of 10 kg without any difficulty. The products of the 10 kg batch were treated with ultrasound and aged for 21 hours respectively. The samples that are aged and without ultrasonic treatment appeared to have a narrower particle size distribution. Table 1 gives data for both cases. FIG. 6 shows the particle distribution of a sample that is aged and without ultrasonic treatment. The synthesized particles of sizes varying from ¼ to ½ λ of the visible light were added to a UV curable coating formulation for evaluation of its anti-reflection and antiglare effects. A typical example of making such a coating is given below.

In a container, a certain amount of F-silica particle IPA suspension, dispersion agents (surfactants), acrylate monomers or/and oligomers, and photo-initiators dissolved in the IPA are added and mixed to form a coating mixture. Then the coating mixture is transferred to an ultrasound bath to be treated for about five minutes. The coating mixture is manually applied onto a TAC film substrate using a coating bar (Meyer 6# or Meyer 8#). The TAC film with wet coating is then transferred into an oven at 70° C. to dry for 3 minutes. The dried coated film is transferred to a UV-curing machine to be cured with a conveyor speed at about 25 FPM and radiation of about 300 WPI. After UV-curing, the coated film is ready for evaluation of optical properties such as haze, gloss, reflection, and clarity.

TABLE 1

Particle size (in nm)

| Aging time | Without ultrasonic | Ultrasonic 20 min. |
|---|---|---|
| fresh | 240 | 301 |
| | 225 | 110 (11%), 309 (88%) |
| | 249 | 285 |
| 21 hours | 205.3 | 190.2 |
| | 209.8 | 193.1 |
| | 206.4 | 194.5 |

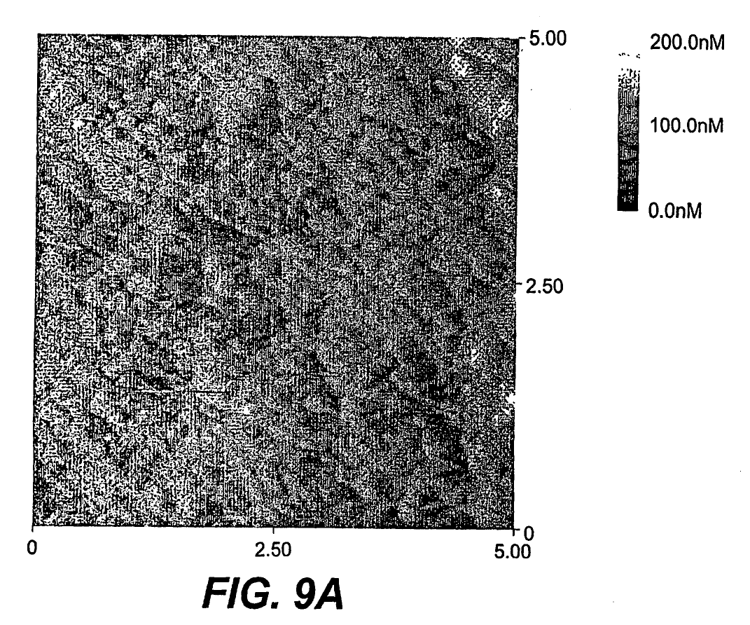

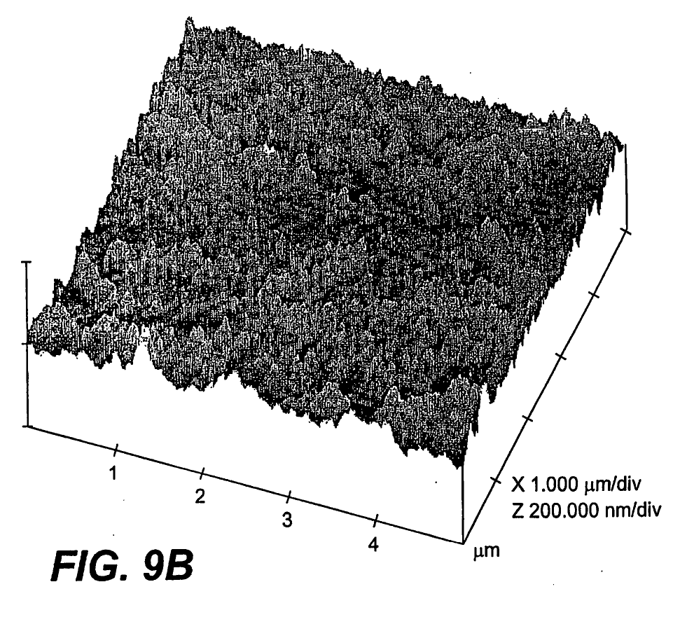

The AR/AG coatings according to the embodiments of the present invention, incorporating self-assembling nanoparticles, include a gradient layer generally comprised of densely packed arrays of the nanoparticles arranged in nanodomains of varying density and varying degrees of encapsulation in the topmost surface of the cured durable resin of high refractive index. Such an arrangement is shown in FIGS. 9A and 9B which are Atomic Force Microscopy (AFM, Dimension 3000 SPM, Digital Instruments Inc) images of the coating surface, formed as described herein, from a formula containing 75 parts of F-silica particles of 250 nm and 100 parts of acrylate resin. FIG. 9A shows a direct observation of the surface morphology. FIG. 9B shows a 3D profile of the surface. Both images were taken from the same spot of the sample (scan size 5.000 μm; set point −2.000V; scan rate 1.001 Hz; number of samples 512).

To further illustrate the unique feature of this invention in terms of varying the AG property without compromising image quality, a series of products have been produced with a wide range of AR-AG properties combinations by varying the F-silica particle size and amount, the coating solid content, viscosity and coater types. The following table gives examples ranging from a high haze value (more AG effect) to a low haze value (a dominant AR effect). Note that despite this wide range of the haze values, the clarities of the samples, measured by distinctness of image (DOI), are consistently high (above 450) as was originally designed from working principals of this invention.

Table 2 reports examples ranging from a high haze value (more AG effect) to a low haze value (a dominant AR effect), as may be produced by embodiments of the coatings of the present invention.

TABLE 2

| | | | Distinctness of | |
|---|---|---|---|---|
| Haze | Total Transmission | 60° Gloss | Image (“DOI”) | Reflection (%) |
| 35.54 | 93.17 | 19.89 | 458.9 | 0.17 |
| 18.97 | 92.27 | 60.63 | 473 | 0.35 |
| 16.79 | 92.65 | 78.96 | 481.7 | 0.56 |
| 10.62 | 92.34 | 97.9 | 484.4 | 1.05 |
| 7.65 | 92.15 | 108.41 | 482.2 | 1.44 |
| 6.11 | 92.31 | 107.78 | 486.4 | 1.01 |
| 5.46 | 92.07 | 117.13 | 482.5 | 1.63 |
| 4.76 | 92.68 | 127.06 | 486.9 | 1.76 |

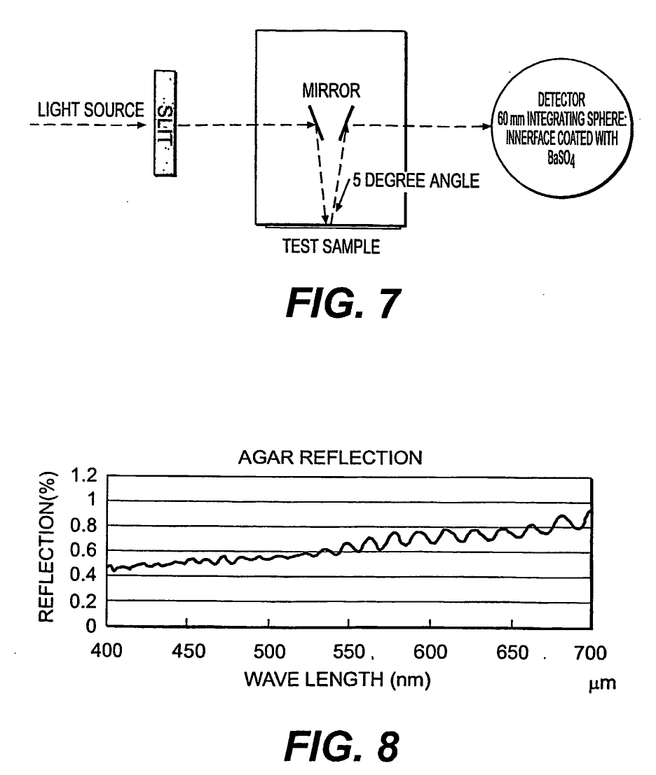

The anti-reflection effect of the coatings of the present invention may be verified by measuring 5° surface reflectance spectrum over wavelength range of the visible light by UV-Visible-NIR Spectrophotometer U-4100, as represented graphically in FIGS. 7 and 8.

Table 3 provides data on various physical properties obtained by two additional embodiments of coatings of the present invention.

TABLE 3¹

| | Sample | |
|---|---|---|
| | AG/AR Low Haze | AG/AR Middle Haze |
| | Type | |
| Feature | AG-Clear Dual layer | AG-Clear Dual layer |
| Thickness (micron) | 88 | 88 |
| 5° reflection | 0.9˜1.1% | 0.3˜0.5% |
| Transmission | >90% | >90% |
| Haze | 13 | 25 |
| 60° Gloss | 40 | 30 |
| Clarity (DOI) | 485 | 460 |
| Hardness | 3H | 3H |
| Adhesion | 100/100 | 100/100 |
| Contact angle | 100 | 100 |

¹Measurement methods:
Thickness: Mitutoyo TD-C112M,
Hardness: YOSHITSU C221A
5° Reflection: HITACHI U-4001,
Gloss: NIPPON DENSHOKU VG-2000
Haze: NIPPON DENSHOKU NDH-2000,
Clarity: SUGA ICM-IT,
Contact angle: FACE CA-D,

As will be appreciated from Tables 2 and 3, embodiments of the present invention are able to improve the optical qualities, such as reducing glittering, color mixing and increasing clarity, of AG/AR coatings. For example, coatings made by embodiments of the invention as described herein provide substantially higher clarity, as compared to known AG/AR coating prepared using the same resin recipe and providing the same level of hardness. Glittering and color mixing observed by visual inspection were much in favor of the new coating according to embodiments of this invention. The clarity of AG/AR according to embodiments of this invention using the Suga test instrument ICM-1T is consistently above 450, significantly better than any existing coating with AG function. The above description relates primarily to embodiments of the antireflection (inlcuding antiglare) coatings according to this invention in connection with applications for optical and/or display devices and other devices and products involving interaction with light waves. However, antireflection coatings according to the present invention and comprising a gradient layer formed by self-assembling of particles at the interface of two media of different properties, may be used for a wide range of applications involving propagation of other wave types, including, for example, electromagnetic waves, sound waves, water waves, etc.

In each case, reflection of waves is caused by a mismatch of impedances at the interface of two transmitting media. A gradient layer of at least ½ wavelength (of the wave of interest) in thickness bridging the gap between the two different media would create destructive interference to substantially reduce reflection. For any of these various different types of waves, a particle, of size determined by the fractional wavelength of the wave of interest, and having an impedance value intermediate the values of the two different media is assembled at the interface of the two different media to achieve a gradient. Accordingly, the antireflection coating of the present invention will be applicable to any wave propagation provided that the thickness of the gradient layer is of practical dimensions, namely, for wavelengths which are not bigger than the dimension of the medium.

One embodiment of the invention therefore includes a gradient layer of impedance for reducing reflection of sound waves, radar waves or infrared rays wherein the gradient layer is made in accordance with any of the embodiments described herein.

Another embodiment of the present invention involves the use of the antireflection coating according to any of the embodiments described herein as the antireflection layer of a solar panel. The solar panel may itself be of any construction of solar panels well known to those skilled in the art.

1. A process for preparing a durable anti-reflection coating effective for use in a low refractive index medium comprising forming a self-assembling gradient layer at the topmost surface of a second phase of a high refractive index, said gradient layer having a refractive index between that of the low refractive index medium and the second phase.

2. The process of claim 1, wherein said self-assembling gradient layer is formed by lowering the interfacial energy of the gradient layer.

3. The process of claim 1, which comprises roll coating the anti-reflection coating on a substrate.

4. The process of claim 3, wherein said substrate is a flexible substrate.

5. The process of claim 4, wherein the flexible substrate comprises a transparent resin.

6. The process of claim 1, wherein said anti-reflection coating is applied by dip coating, spin coating or spray coating the anti-reflection coating on a substrate.

7. The process of claim 3, wherein said substrate is a non-flexible substrate.

8. The process of claim 1, wherein said gradient layer comprises nanoparticles.

9. The process of claim 8 wherein said nanoparticles have a diameter between about one-eighth to about one wave length of visible light.

10. The process of claim 8 wherein said nanoparticles have a diameter of about one-half wavelength of visible light.

11. The process of claim 8, wherein said nanoparticles have a wavelength which is a multiple of about one-half wavelength of visible light.

12. The process of claim 8, wherein said nanoparticles are made by a Stöber process.

13. The process of claim 8, wherein a surface active compound is applied to said nanoparticles.

14. The process of claim 8, wherein the nanoparticles further comprise a fluorocarbon group.

15. The process of claim 12, wherein the nanoparticles further comprise a fluorocarbon group.

16. The process of claim 15, wherein said nanoparticles have a diameter of between 100 to 600 nanometers.

17. The process of claim 8, wherein the nanoparticles are partially embedded in a hard cured resin material comprising the second phase of a high refractive index.

18. A process for preparing an antireflection coating which comprises depositing a coating composition comprising supramolecules in a solvent solution of a curable resin under conditions whereby the molecular interacting forces between the supramolecules and the solvent solution is selected to cause the supramolecules to spontaneously rise to and partially extend from the topmost surface of the solvent solution, wherein the concentration of supramolecules is sufficient to at least form a densely packed layer of the supramolecules partially embedded at the topmost surface of the curable resin when cured, and wherein the refractive indexes of the supramolecules and the curable resin, after curing, are selected such that the resulting coating provides a gradient of refractive indices increasing from the topmost surface through the thickness of the cured resin, driving off the solvent and curing the deposited curable resin, whereby a densely packed array of supramolecules is partially embedded at the topmost surface of the cured resin.

19. The process according to claim 18, wherein the supramolecules comprise silica nanoparticles.

20. The process according to claim 18, wherein the supramolecules comprise silica nanoparticles modified with functional groups promoting the self-assembling process.

21. The process according to claim 20, wherein the functional groups comprise fluorine.

22. The process according to claim 21, wherein the curable resin comprises an acrylate resin.

23. The process according to claim 22, wherein the solvent comprises isopropyl alcohol.

24. The process according to claim 18, wherein the supramolecules comprise nanoparticles of polymeric material having a refractive index lower than that of the curable resin.

25. An anti-reflection coating made according to the process of claim 1.

26. A high-resolution, antiglare and antireflection coating made according to the process of claim 18.

27. A display device comprising a high-resolution, multi-functional coating according to claim 26.

28. An optical devices comprising the high-resolution, multi-functional coating according to claim 26.

29. The optical device according to claim 28 which is a eyeglass lens.

30. The optical device according to claim 28 which is a microscope or telescope lens.

31. A telecommunication device comprising a high-resolution, multi-functional coating according to claim 26.

32. A display screen of a cellular telephone or PDA device comprising a high-resolution, multi-functional coating according to claim 26.

33. A solar panel comprising the coating made by the process of claim 1.

34. A display device providing a waveguide function comprising a coating according to the process of claim 1.

35. A method for increasing optical brightness or contrast ratio of a display device having a viewing screen comprising applying a coating according to claim 25 on said viewing screen.

36. A gradient layer of impedance for reducing reflection of sound waves, radar waves or infrared rays comprising an antireflection coating according to claim 25.

37. An antireflection coating for a substrate which during use thereof is exposed to an ambient low refractive index medium, comprising:
a second phase having a refractive index higher than that of the ambient low refractive index medium; and
a gradient layer partially embedded at the topmost surface of the second phase comprising self-assembled nanoparticles;
wherein the refractive index of the gradient layer varies gradually from the refractive index of the ambient low refractive index medium to the refractive index of said second phase.

38. An antireflection coating according to claim 37, wherein the gradient layer comprises said self-assembled nanoparticles partially embedded in a cured resin.

39. An antireflection coating according to claim 37, wherein the gradient layer further comprises ambient low refractive index medium between the non-embedded portions of said nanoparticles.

40. An antireflection coating according to claim 37, wherein the nanoparticles comprise Stöber process particles.

41. An antireflection coating according to claim 40, wherein the Stöber process particles comprise silica.

42. An antireflection coating according to claim 40, wherein the Stöber process particles comprise fluorinated silica particles.

43. An antireflection coating according to claim 42, wherein the fluorinated silica particles comprise tridecafluoro-1,1,2,2-tetrahydrooctyl groups bonded to the silica particles.

44. An antireflective substrate, comprising the antireflection (antireflective) coating of claim 37 on a substrate.

45. An antireflective substrate according to claim 44, wherein the substrate is transparent.

46. An antireflective substrate according to claim 44, wherein the substrate comprises glass.

47. An antireflective substrate according to claim 44, wherein the substrate comprises transparent resin.

48. An antireflective substrate according to claim 44, wherein the substrate comprises triacetyl cellulose.

49. An antireflection coating comprising a layer of a durable resin of high refractive index and a gradient layer of refractive indices at the topmost surface of the durable resin layer, said coating having a haze in the range of 4 to 40, a reflection of from 1.8 to 0.1% and a distinctness of image (DOI) of at least about 450.

50. An antireflection coating according to claim 49, wherein the gradient layer comprises nanoparticles arranged in domains of varying density and varying degrees of encapsulation in the topmost surface of the durable resin.

51. A solar panel comprising the coating made by the process of claim 18.

52. A display device providing a waveguide function comprising a coating according to the process of claim 18.
